(19) United States
(12) Patent Application Publication
(10) Pub. No.: US 2005/0108299 A1
(43) Pub. Date: May 19, 2005

(54) Real-time Web sharing system

(75) Inventor: Kazuaki Nakajima, Tokyo (JP)

Correspondence Address: MCGINN & GIBB, PLLC, 8321 OLD COURTHOUSE ROAD, SUITE 200, VIENNA, VA, 22182-3817, US

(73) Assignee: NEC Corporation, Tokyo (JP)

(21) Appl. No.: 10/990,387

(22) Filed: Nov. 18, 2004

(30) Foreign Application Priority Data
Nov. 19, 2003 (JP) 389471/2003

(51) Int. Cl. G06F 7/00

(52) U.S. Cl. 707/201

(57) ABSTRACT

A real-time Web sharing system includes a Web server, a relay server and a sharing control server. The Web server is connected with a network and stores Web contents. The relay server is connected with the network and has a storage section. When receiving an access request with an URL from one client, the relay server determines whether the access request with the URL is a first time access request to the URL. The relay server downloads the Web page of the Web contents corresponding to the URL from the Web server when it is determined that the access request is the first time access request to the URL, stores the downloaded Web page in the storage section, and delivers the Web page to the one client. Also, the relay server reads out the Web page from the storage section when it is determined that the access request is not the first time access request to the URL, rewrite the read out Web page and delivers the rewritten Web page to the one client. The sharing control server is connected with the network, and which controls synchronization of the rewritten Web page between a plurality of clients including the one client, when the rewritten Web page is browsed by the plurality of clients.

### BACKGROUND OF THE INVENTION

1. Field of the Invention

The present invention relates to a system for sharing Web contents between terminals.

2. Description of the Related Art

Various techniques using network resources have been developed in accordance with proceeding of the network technology. Especially, a system in which Web pages on WWW (World Wide Web) are shared in a particular group in real-time is effective to a precise data exchange. Conventionally, as methods of sharing same Web pages in real-time between a plurality of terminals through a network, there are a method of sharing displays of the Web pages and a method of establishing synchronization of the Web pages between browsers, as described in Japanese Patent No. 3,437,933.

In the method of sharing displays of the Web pages, a particular environment is provided for a self terminal and an opponent terminal for communication. The same Web pages are displayed on both of the terminals based on the particular environment. This method is suitable for a system in which there is a margin in communication resources and is flexibly adaptive for a limitation applied by the environment, in which an operation to a pop-up menu is not necessary.

In the method of establishing synchronization of the Web pages between the browsers, optional Web contents are downloaded from a WWW server by using the browser in a terminal. When the Web contents are downloaded, the browser rewrites the downloaded Web contents by using a script program. The rewrite of the Web contents is carried out so as to share a user action among the browsers. The browsers communicate with each other through a real-time Web contents sharing server. As a result, when any action is carried out onto the contents under the browser by the user, the action is shared, and the inside of the plurality of browsers are changed. Thus, the real-time Web sharing is achieved.

Also, Japanese Patent No. 3,283,018 discloses another conventional method of sharing Web pages, in which an agent is provided between a server and terminals. The agent executes sharing of URLs (Uniform Resource Locator) in accesses to the server. To achieve such Web contents sharing, an exclusive browser is generally used rather than a general-purpose browser.

The accesses to the server are generated when the synchronization is established among the browsers because the Web system is of a server client type. Therefore, when the conventional real-time Web contents sharing is carried out, many accesses to the Web server are generated at one time. Thus, a system is demanded in which the consistency of the Web contents is controlled on the server side, and accesses to same Web contents from a plurality of browsers are permitted.

Also, generally, a script program for conventional real-time Web sharing is used to access only Web contents in the same domain as a Web server, from which the script program is downloaded. A general-purpose browser keeps high security because it handles optional contents. Therefore, a real-time Web contents sharing system is demanded in which the Web contents of an optional server can be browsed by using the general-purpose browser.

In conjunction with the above description, a Web page sharing system is disclosed in Japanese Laid Open Patent Application (JP-P2001-333062A). In this conventional example, the Web page sharing system includes a first server which provides a data file specified by an address data. Each of a plurality of terminals transmits the address data corresponding to a desired data file to the first server to access it, and acquires the data file returned from the first server in response to the said address data. A second server transmits the address data when any of the terminals accesses the first server to another terminal. The other receives the address data from the second server, accesses to the first server based on the transferred address data, and acquires a data file returned from the first server in response to the transferred address data.

Also, a server system is disclosed in Japanese Laid Open Patent Application (JP-A-Heisei 10-116238). In this conventional example, a server system communicates at least one device which has a browser for receiving data from at least one source other than the server system through a communication network. The server system receives from the device, a participation request to session that the browser receives the data, and provides the device with a code to generate an agent for receiving the data from the browser in response to the request, and includes at least one controller which receives said data from the agent.

Also, a real time Web sharing system is disclosed in International Publication (WO 2004/049180 A1) of an international application which claims the priority based on Japanese Patent application No. 2002-343721. The disclosure of the international application is incorporated herein by reference. In this example, a server has a section for transmitting a detection script for detecting update of a Web page and an update script for updating the Web page. Also, the server has a section for transmitting a Web page update notice received from a predetermined terminal to another terminal which brows the same Web page as the predetermined terminal. Each of the terminals receives the detection script and the update script, transmits the Web page update notice to the server when the update of the Web page is detected by the detection script, and makes the update script update the Web page in response to the received Web page update notice.

### SUMMARY OF THE INVENTION

An object of the present invention is to provide a real-time Web contents sharing system, in which the consistency of the Web contents is controlled on the server side, and accesses to same Web contents from a plurality of browsers are permitted.

Another object of the present invention is to provide a real-time Web contents sharing system, in which the Web contents of an optional server can be browsed by using the general-purpose browser.

Another object of the present invention is to provide a real-time Web contents sharing system, in which multiple accesses to a web server can be prevented.

In an aspect of the present invention, a real-time Web sharing system includes a Web server, a relay server and a sharing control server. The Web server is connected with a network and stores Web contents. The relay server is connected with the network and has a storage section. When receiving an access request with an URL from one client, the relay server determines whether the access request with the URL is a first time access request to the URL. The relay server downloads the Web page of the Web contents corresponding to the URL from the Web server when it is determined that the access request is the first time access request to the URL, stores the downloaded Web page in the storage section, and delivers the Web page to the one client. Also, the relay server reads out the Web page from the storage section when it is determined that the access request is not the first time access request to the URL, rewrite the read out Web page and delivers the rewritten Web page to the one client. The sharing control server is connected with the network, and which controls synchronization of the rewritten Web page between a plurality of clients including the one client, when the rewritten Web page is browsed by the plurality of clients.

Here, the relay server may include a determining section which determines whether the access request is the first time access request to the URL; and an update section which rewrites the Web page read out from the storage section such that URLs contained in the read out Web page are rewritten into substitution URLs. Each of the substitution URL may contain a sharing group data, a sharing status data and a serial number corresponding, and the determining section determines whether the access from the client is the first time access, based on the serial number.

Also, the sharing control server may include a sharing setting section. The relay server may allocate a specific sharing group data to the one client to define a sharing group of the plurality of clients. A synchronization request of the Web page and the specific sharing group data are transferred to the plurality of clients other than the one client, and each of the plurality of clients other than the one client downloads the rewritten Web page corresponding to the specific sharing group data from the relay server in response to the synchronous request. The sharing control server controls the synchronization of the rewritten Web page between the plurality of clients based on the specific sharing group data.

In this case, the relay server may allocate another specific sharing group data to a client different from the plurality of clients in response to a new access request to the URL from the different client while the rewritten Web page is browsed by the plurality of clients. The sharing control server independently controls the synchronization of the rewritten Web page to the sharing group corresponding to the specific sharing group data and the synchronization of the Web page to another sharing group corresponding to the another specific sharing group data.

Also, the determining section may determine that the access request with the URL is the first time access request when there is no access request to the serial number. The update section may give an access data to the serial number in response to the determination that the access request with the URL is the first time access request.

In this case, the determining section may determine that a first access request to the substitution URL with the access data added to the serial number is not the first time access request, and generates a first notice of the first access request to the substitution URL with the access data added to the serial number to the update section. The update section may update the access data of the substitution URL with the access data added to the serial number in response to the first notice.

In this case, the determining section may determine that a second access request to the substitution URL with the access data added to the serial number is the first time access request when transition of the Web page is not detected, and generate a second notice of the second access request to the substitution URL with the access data added to the serial number to the update section. The update section may update the access data in response to the second notice.

Also, the relay server may further include a script storage section which stores a script program to rewrite the Web page. The relay server may deliver the script program corresponding to the access request in addition to the rewritten Web page to the one client when the access request is not the first time access request.

In this case, the script storage section may store the script program corresponding to each of a plurality of the Web servers connected with the network. The relay server may select one of the plurality of Web servers based on the access request from the one client, and delivers the script program corresponding to the selected Web server and the rewritten Web page corresponding to the access request to the one client.

Also, each of the plurality of clients other than the one client may transmit a reception notice to the relay server in response to the allocation of the specific sharing group data. The relay server may set a code in the sharing status data in response to the allocation, and controls connection to the sharing control server based on the code.

Also, the relay server may deliver the rewritten Web page to a new client in response to a new access request to the rewritten Web page, to which the synchronization is controlled, from a new client different from the plurality of clients. The sharing control server may control the synchronization between the new client and the plurality of clients.

In another aspect, the present invention relates to a computer readable software product for realizing a process including the following steps. The process is achieved by receiving an access request with an URL from one client of a plurality of clients; by determining whether the access request with the URL is a first time access request to the URL; by downloading the Web page of the Web contents corresponding to the URL from a Web server when it is determined that the access request is the first time access request to the URL; by storing the downloaded Web page in a storage section; by delivering the Web page to the one client; by reading out the Web page from the storage section when it is determined that the access request is not the first time access request to the URL; by rewriting the read out Web page; and by delivering the rewritten Web page to the one client.

The rewriting may be achieved by rewriting the Web page read out from the storage section such that URLs contained in the read out Web page are rewritten into substitution URLs. Each of the substitution URL contains a sharing group data, a sharing status data and a serial number. The determining may be achieved by determining whether the access from the client is the first time access, based on the serial number.

In this case, the process may include allocating a specific sharing group data to the one client to define a sharing group of the plurality of clients. A synchronization request of the Web page and the specific sharing group data are transferred to the plurality of clients other than the one client, and each of the plurality of clients other than the one client downloads the rewritten Web page corresponding to the specific sharing group data from the relay server in response to the synchronous request.

In this case, there may be a step of allocating another specific sharing group data to a client different from the plurality of clients in response to a different access request to the URL from the different client while the rewritten Web page is browsed by the plurality of clients.

Also, the determining may be achieved by determining that the access request with the URL is the first time access request when there is no access request to the serial number. The rewriting may be achieved by giving an access data to the serial number in response to the determination that the access request with the URL is the first time access request.

In this case, the determining may be achieved by determining that a first access request to the substitution URL with the access data added to the serial number is not the first time access request; and by generating a first notice of the first access request to the substitution URL with the access data added to the serial number. The rewriting may be achieved by updating the access data of the substitution URL with the access data added to the serial number in response to the first notice.

In this case, the determining may be achieved by determining that a second access request to the substitution URL with the access data added to the serial number is the first time access request when transition of the Web page is not detected; and by generating a second notice of the second access request to the substitution URL with the access data added to the serial number. The rewriting may be achieved by updating the access data in response to the second notice.

Also, the delivering the rewritten Web page may be achieved by delivering the script program corresponding to the access request in addition to the rewritten Web page to the one client when the access request is not the first time access request.

In this case, the delivering the rewritten Web page may be achieved by selecting one of the plurality of Web servers based on the access request from the one client; and by delivering the script program corresponding to the selected Web server and the rewritten Web page corresponding to the access request to the one client.

Also, said process may be achieved by additionally carrying out of generating a reception notice from each of the plurality of clients other than the one client in response to the allocation of the specific sharing group data. The rewriting may be achieved by setting a code in the sharing status data in response to the allocation, and controls connection to the sharing control server based on the code.

### BRIEF DESCRIPTION OF THE DRAWINGS

FIG. 1 is a conceptual diagram showing the system hardware configuration of a real-time Web content sharing system of the present invention;

FIG. 2 is a functional block diagram showing the system structure of the real-time Web content sharing system according to an embodiment of the present invention;

FIG. 3 is a diagram showing a substitution URL used in the real-time Web content sharing system in this embodiment;

FIGS. 4A and 4B are diagrams showing an example of URL used to access a server and Web contents;

FIG. 5 is a diagram showing an example of relative URL contained in HTML contents;

FIG. 6 is a diagram showing an example of the substitution URL after access to relative URL contained in the HTML contents;

FIG. 7 is a flow chart showing operations of a customer terminal and an operator terminal in case of the real-time Web contents sharing;

FIG. 8 is a flow chart showing a synchronizing operation of the Web contents to execute real-time Web contents sharing; and

FIG. 9 is a flow chart showing an operation of a relay server when page transfer is carried out in a sharing state.

### DESCRIPTION OF THE PREFERRED EMBODIMENTS

Hereinafter, a real-time Web contents sharing system of the present invention will be described with reference to the attached drawings.

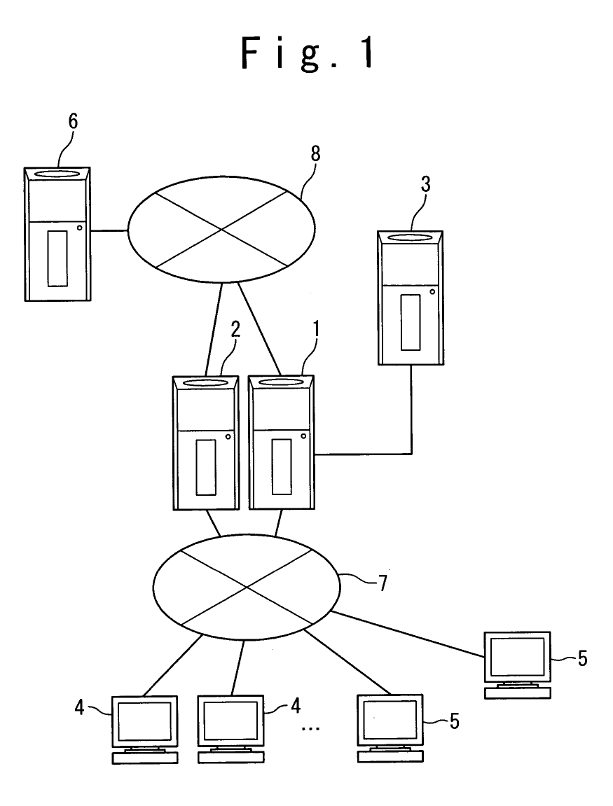

FIG. 1 is a block diagram showing the system configuration of the real-time Web contents sharing system according to the embodiment of the present invention. Referring to FIG. 1, the real-time Web contents sharing system of the present invention contains a sever side and a client side connected through a network 7. The server side includes a relay server 1, a sharing control server 2, a Web contents server 3, and a Web contents server 6. Each of the relay server 1 and the sharing control server 2 is connected with the network 7. The Web contents server 3 is connected with the relay server 1. The contents server 6 is connected with the relay server 1 through a network 8. The networks 7 and 8 may be same. On the other hand, the client side includes a plurality of customer terminals 4 and a plurality of operator terminals 5. Each of the customer terminals 4 and the operator terminals 5 is connected with the relay server 1 through the network 7. The network 7 is a data communication network that is exemplified by the Internet.

The relay server 1 relays data between the customer terminals 4 or the operator terminals 5 and the Web contents server 3. Also, the relay server 1 stores the web contents downloaded by the Web contents server 3 and provides the stored Web contents to be shared in Web contents sharing in place of the Web contents server 3.

The sharing control server 2 executes a data process for real time sharing when the customer terminals 4 and the operator terminals 5 share a Web page of the Web contents through the relay server 1. Also, the sharing control server 2 controls or manages the Web contents sharing of the Web pages by the customer terminals 4 and the operator terminals 5 through the network 7. Thus, it is possible to carry out the Web contents sharing between optional terminals by the sharing control server 2. For instance, it is possible to form one sharing group of one customer terminal 4 and one operator terminal 5 at the same time of forming another sharing group of other customer terminals 4 and other operator terminals 5. The combination of terminals belonging to such a group is optional. For example, the customer terminal 4 may be newly assigned to an existing sharing group.

The Web contents server 3 provides the Web contents to each of the customer terminals 4 or the operator terminals 5 through the relay server 1. The Web contents server 3 is accessed by each of the customer terminals 4 and operator terminals 5 through the relay server 1. The Web contents server 3 may provide the web contents to a terminal which is not in the real-time Web contents sharing, i.e., the terminal which is connected with the Web contents server 3 without passing through the relay server 1.

The customer terminal 4 is a data processing terminal for a customer who receives the web contents service. The customer terminal 4 is connected with the network 7, and has a communication function for data communication through the network 7. The customer terminal 4 further has a function to input a data or commend, and a function to output a data. It is desirable to provide the customer terminal 4 for every customer.

The operator terminal 5 is a data processing terminal for the operator who mediates the customer and a provider of the Web contents service. The operator terminal 5 is connected with the network 7, and has a communication function for data communication through the network 7. Further, the operator terminal 5 has a function to input a data or command and a function to output a data. It is desirable to provide at least one operator terminal 5 for every operator. The operator terminal 5 may be arranged in either of the client side or the server side in the system of the embodiment, and can be achieve the Web contents sharing. The sharing group can be optionally configured between the customer terminals 4 and the operator terminals 5, and the real-time Web contents sharing in the sharing group is achieved by the relay server 1 and the sharing control server 2.

The Web contents server 6 is a server connected with the relay server 1 and the sharing control server 2 through the network 8 to provide Web contents, and may be provided on an arbitrary position in the server side of the system. The Web contents server 6 responds to an access request with an URL from the customer terminal 4 or the operator terminal 5 through the relay server 1.

The relay server 1 is accessible from other Web contents servers connected with the network 7 or 8. The relay server 1 can rewrite the Web contents provided by the Web contents server 3 or 6 to have a format in which the real-time Web contents sharing is possible, and delivers the rewritten Web contents to the customer terminal 4 or the operator terminal 5.

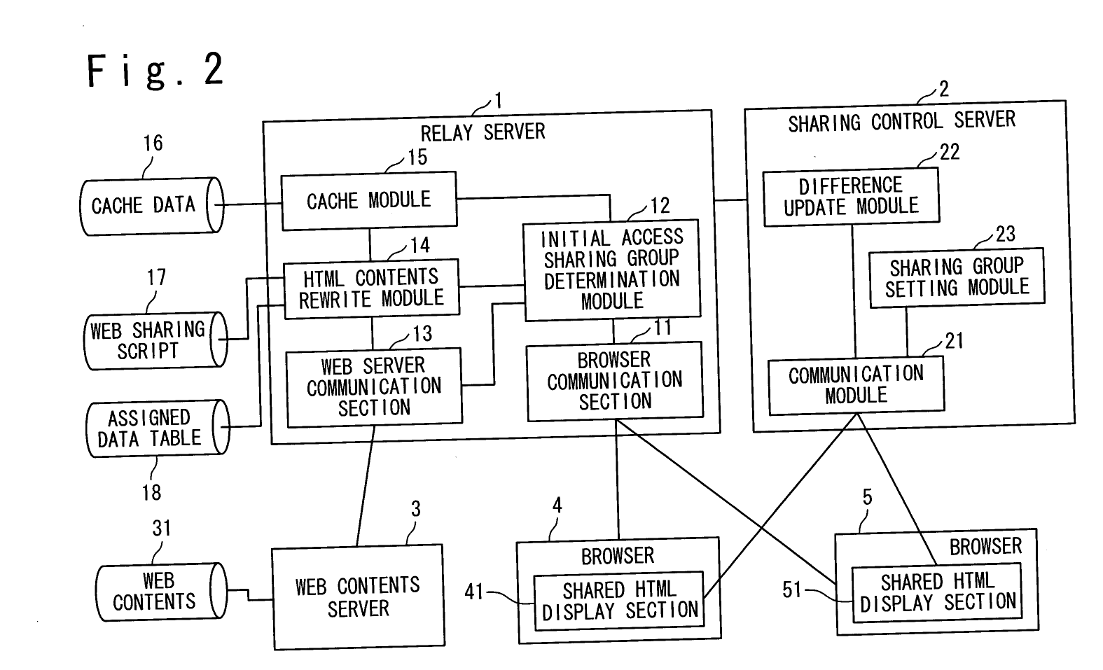

FIG. 2 is a block diagram showing a system configuration of the embodiment. The relay server 1 includes a browser communication section 11 and an initial access/sharing group determination module 12, a Web server communication section 13, a HTML (Hypertext Markup Language) contents rewrite module 14, and a cache module 15. The relay server 1 further contains a cache data storage section 16, a Web sharing script storage section 17, and an assigned data table storage section 18. The browser communication section 11 is connected with the determination module 12. The determination module 12 is connected with the Web server communication section 13, the HTML contents rewrite module 14 and the cache module 15. The Web server communication section 13 is connected with the Web contents server 3 and the HTML contents rewrite module 14 which is connected with the cache module 15, the Web sharing script storage section 17 and the assigned data table storage section 18. The cache module 15 is connected with the cache data storage section 16.

The browser communication section 11 operates as a HTTP server. The relay server 1 communicates with each of the customer terminals 4 and the operator terminals 5 through the browser communication section 11 by using the HTTP communication. The relay server 1 is not recognized as a proxy server but as a Web server by the customer terminals 4 and the operator terminals 5. Therefore, a user (customer or operator) can access the relay server 1 by carrying out a proxy setting of the customer terminal 4 or the operator terminal 5, as in case to access the Web server. That is, in the light of the access method of URL, the user can access the relay server 1 as the Web server. The browser communication section 11 sends URL data contained in an access request from one terminal 4 or 5 to the determination module 12, and holds a response to the terminal 4 until a response from the determination module 12 is received. When the holding state is canceled, the browser communication section 11 transmits the Web page of the Web contents and a rewritten URL to the terminal 4 or 5 which has issued the access request.

The determination module 12 analyzes the URL data sent from the browser communication section 11 based on a URL data table (not shown) of the cache module 15. That is, the determination module 12 determines whether the same URL data exists in the URL data table. If there is no same URL data, a transmitted access request with the URL data is determined to be the first time access request. At this time, the determination module 12 transmits the URL data to the HTML contents rewrite module 14 and issues an access instruction to the Web server communication section 13 such that the Web server communication section 13 accesses the Web contents server 2 to download a Web page of the Web contents corresponding to the URL data from the Web contents server 2. If there is the same URL data, the determination module 12 determines that the access request is not the first time access request and the Web page of the Web contents is already accessed by another terminal. Thus, the determination module 12 starts the synchronization control of the Web contents between a terminal corresponding to the already received access request and the terminal corresponding to this access request. At this time, the determination module 12 issues an access instruction to the Web server communication section 13 and requests the Web server communication section 13 to acquire the Web contents from the cache module 15. When a downloading operation is being carried out at this time, the Web server communication section 13 keeps a waiting state until the downloading operation is completed.

The Web server communication section 13 is a communication interface connected with the Web contents server 3. The Web server communication section 13 accesses the Web contents server 3 based on the relay server URL in response to the access instruction from the determination module 12 and starts download of the Web contents from the Web contents server 3. Then, the Web server communication section 13 transfers the control to the HTML contents rewrite module 14 in response to the downloading completion of the Web contents from the Web contents server 3.

The HTML contents rewrite module 14 rewrites the URL data transmitted from the determination module 12 into a relay server URL and rewrites the Web contents transferred from the Web server communication section 13 by using the Web sharing script stored in the storage section 17. In this case, the HTML contents rewrite module 14 rewrites a portion of the Web contents page written in HTML, but does not rewrite other contents such as an image. For instance, the HTML contents rewrite module 14 rewrites scripts such as anchor tags, and converts a relative URL into a substitution URL. After the conversion, the rewritten Web contents page is transferred to the cache module 15 and the determination module 12.

The cache module 15 has the URL data table, and holds the Web page of the Web contents transmitted from the HTML contents rewrite module 14 temporarily and stores the URL data table and the Web contents page in the cache data storage section 16. The determination module 12 refers to the URL data table in response to an inquiry from the determination module 12 and acquires a data indicative of whether or not the same URL data exists. The Web contents page downloaded from the Web contents server 3 is stored in the cache module 15 temporarily and then stored in the cache data storage section 16. If a flag is set in the URL data table to show that the Web contents page is being written, the cache module 15 holds a waiting state to the inquiry from the browser communication section 11. If the flag is not set, the Web contents page is delivered immediately to the terminal which has generated the access request.

The cache data storage section 16 is a data storage section to store the Web contents pages downloaded from the Web contents server 3. The cache data storage section 16 has the URL data table, and provides the URL data table to the cache module 12 when the cache module 15 is requested from the determination module 12, in order to determine whether the same URL data exists.

The Web sharing script storage section 17 is a storage section to store various scripts such as Web sharing scripts for sharing the Web contents page used for the rewrite and conversion by the HTML contents rewrite module 14. The HTML contents rewrite module 14 inserts various scripts such as the Web sharing scripts acquired from the storage section 17 into the Web contents page to be delivered.

The assigned data table storage section 18 is a storage section to store an assigned data table showing a correspondence relation between the URL data and each of the scripts such as the Web sharing script. The assigned data table is used to select the Web sharing script to be inserted for every conventional URL or terminal of the sharing group when the Web sharing script 17 should be inserted in the Web contents page. Since the sharing control server 2 cannot previously specify the Web contents from the Web contents server 6, a general script is used. On the other hand, when the Web contents server 3 is accessed to acquire Web contents page, and a button that cannot be operated on the customer terminal is displayed and a memorandum that is to be shown on only the operator terminal is displayed, the Web sharing script to be inserted is specified based on the assigned data table.

The sharing control server 2 includes a communication module 21, a difference update module 22, and a sharing group setting module 23.

The communication module 21 communicates with a shared HTML display section 41 of a browser in the customer terminals 4 and a sharing HTML display sections 51 of a browser in the operator terminals 5. The shard HTML display sections 41 and the shard HTML display sections 51 display the same Web contents page when the terminals belong to the same sharing group. A plurality of shared HTML display sections 41 or 51 may exist in the one terminal at the same time. The communication module 21 can communicate with the Web sharing scripts buried in the Web contents page on the shared HTML display sections 41 and 51.

The sharing group setting module 23 manages the setting of a sharing group. For example, the difference update module 22 assigns and sets the operator terminal 5 to the sharing group to which the customer terminal 4 having issued the access request belongs. As a result, the communication module 21 can recognize the sharing group.

The difference update module 22 is a module to transmit and receive a difference update command. The sharing group setting module 23 transmits a difference data transmitted from the communication module 21 to the terminals of the group other than the transmitting terminal of the difference data, as the difference update command. The shared Web contents page is rewritten so as to add a Web sharing script program. As a result, an action of the user of the customer terminal 4 displaying the downloaded Web contents page is reflected to other terminals in the sharing group through the browsers by the Web sharing script program. A portion of the Web contents page is rewritten to capture an event and to send it to the sharing control server 2 as a difference update command. Also, the portion of the Web contents page is rewritten in such a way that the event is executed when the difference update command is received from each of the terminals 4 and 5 of the sharing group through the difference update module 22. The communication module 21 is connected with the sharing group setting module 23 and the difference update module 22.

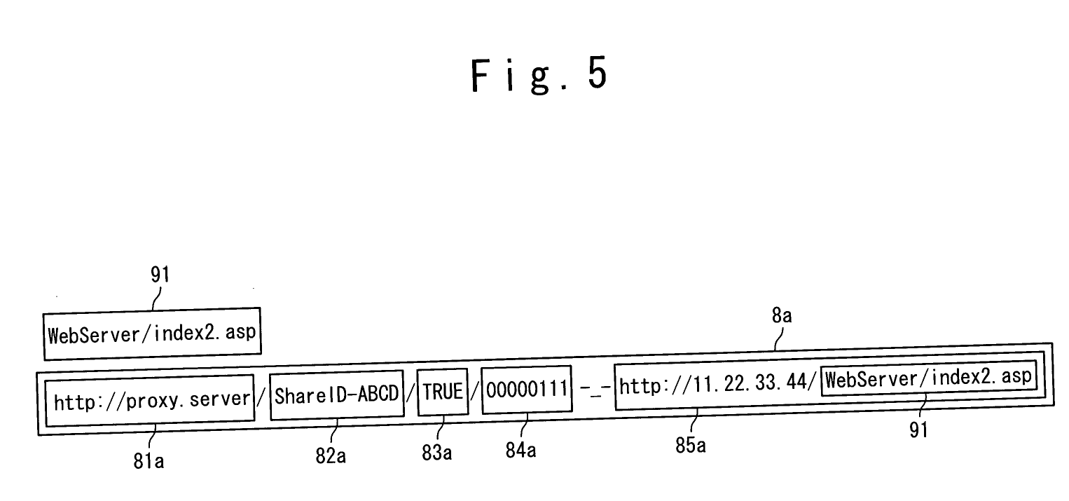

Each of the customer terminal 4 and the operator terminal 5 includes the shared HTML display sections 41 or 51 on which the shared Web contents page is displayed by a browser. When both of the customer terminal 4 and the operator terminal 5 belong to the same sharing group, each of them communicates with the relay server 1 and the sharing control server 2 such that the shared HTML display section 41 or 51 shares a same Web page of the same Web contents in real time, resulting in synchronization between them. Each of the shared HTML display section 41 and 51 receives and holds a first substitution URL 8a sent from the relay server 1 and shown in FIG. 5. The first substitution URL 8a is obtained by rewriting an original URL in such a manner that the Web contents server 3 is accessed through the relay server 1 in response to a user action in future. Moreover, each of the customer terminals 4 and the operator terminals 5 can share the user action by communicating with the sharing control server 2, such that all the user actions in the browser such as an access to the servers, input of data into a form and scrolling in the browser are reflected between the customer terminals 4 and the operator terminals 5 in real time.

The Web contents server 3 is a server which has the same function as a conventional WWW server. The Web contents server 3 has the Web contents 31. It is not necessary to modify the Web contents server 3. The Web contents server 3 can be applied to the system of the present invention as it is, continuing to provide users with usual service by the WWW server.

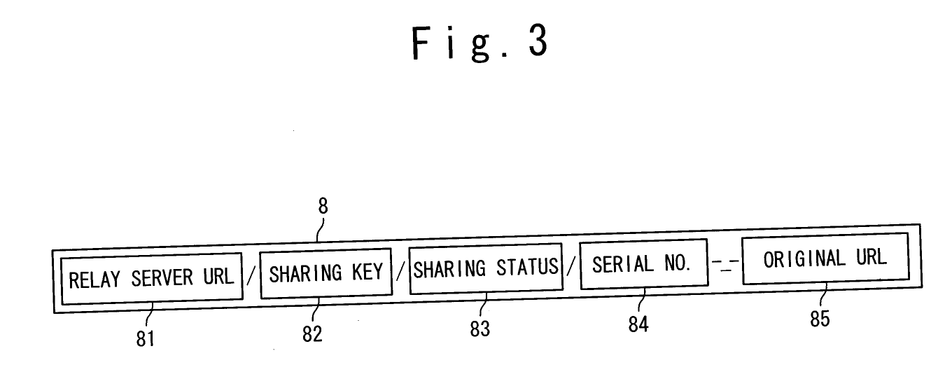

FIG. 3 is a block diagram showing the configuration of the substitution URL 8 obtained by rewriting an original URL by the HTML contents rewrite module 14 in the embodiment. Referring to FIG. 3, the substitution URL 8 includes a relay server URL 81, a sharing key 82, a sharing status 83, and a serial number 84. The relay server URL 81 is an identifier used to access the relay server 1 as a Web contents server. The sharing key 82 is an identifier to identify a sharing group. The sharing status 83 is an identifier indicating whether the sharing group is formed. The sharing status 83 does not exist when only one terminal accesses. “TRUE” is used as an identifier showing the generation of the sharing status in the embodiment. The serial number 84 is primarily assigned to each of anchor tags and URLs when the HTML contents rewrite module 14 rewrites the URL data in the HTML contents page to be delivered by the relay server 1. An original URL is used for a terminal to access the Web contents sharing server 3 without passing through the relay server 1.

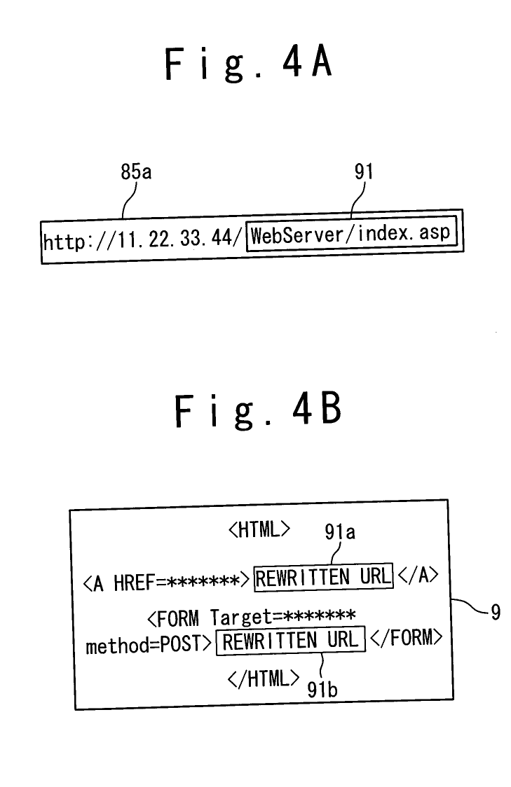

FIG. 4A shows an URL data when the Web contents page is accessed. An original URL 85a is a usual URL used when a terminal accesses the Web content server 3. The original URL 85a is composed of a protocol name, a domain name, “/” for partition, a directory name, and a file name. FIG. 4B shows the HTML contents 9 as an example of the Web contents corresponding to the URL data shown in FIG. 4A. The HTML contents 9 include a plurality of relative URLs 91a and 91b. The relative URL 91a shows an example of an URL of an anchor tag, and the relative URL 91b shows an example of the URL of form transmission by POST.

FIG. 5 shows an example of the relative URL 91 contained in the HTML contents 9 and the relative URL 91 is rewritten into a substitution URL 8a by the HTML contents rewrite module 14 of the relay server 1 when the HTML contents 9 are acquired through the relay server 1. Referring to FIG. 5, the substitution URL 8a is composed of an URL data 81a of the relay server 1, a sharing key 82a, a sharing status 83a, a serial number 84a, and the original URL 85a.

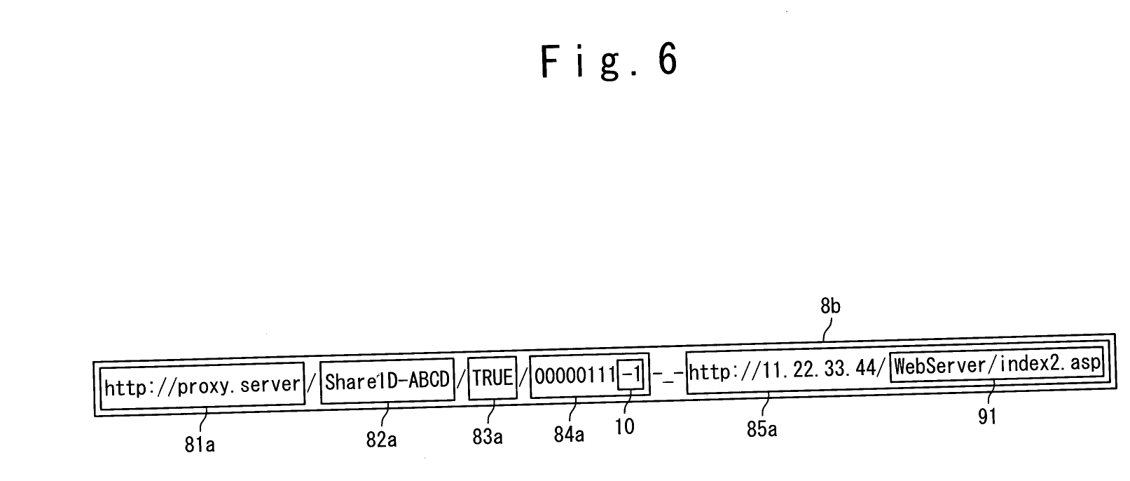

FIG. 6 shows an example of a substitution URL 8b obtained by rewriting the substitution URL 8a after the access using the substitution URL 8a. Referring to FIG. 6, the first substitution URL 8b is basically the same as the first substitution URL 8a. The different point is in that data “−1” is added to the serial number 84a.

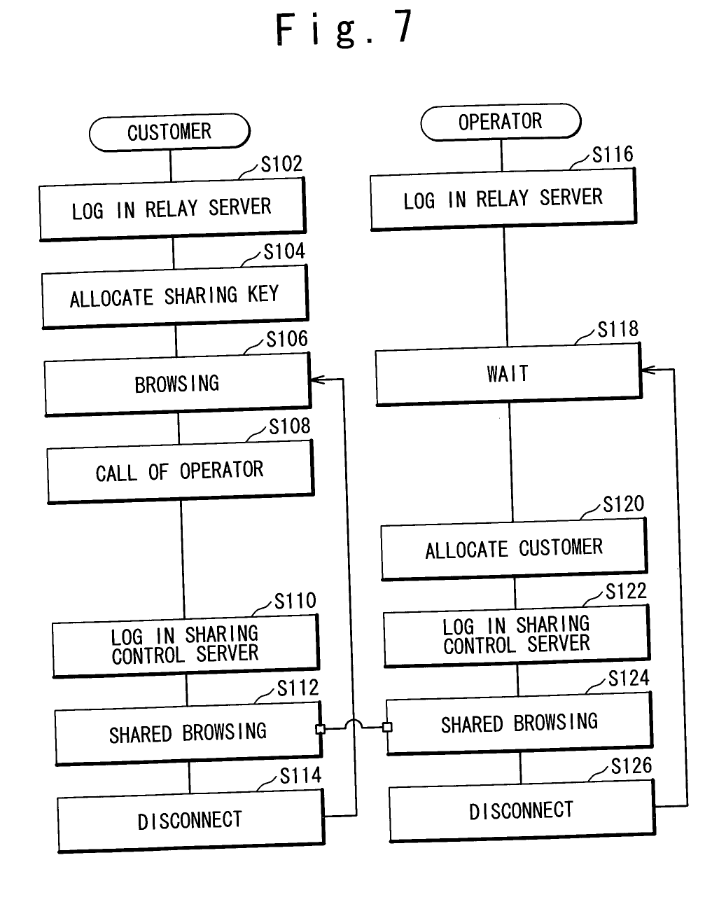

Hereinafter, an operation of the present invention will be described with reference to the drawings. FIG. 7 is a flow chart showing operations of customer terminal and operator terminal in the real-time Web contents sharing. Steps S102 to S114 show an operation of the customer terminal 4, and steps S116 to S126 shows an operation of the operator terminal 5. In the operation shown in FIG. 7, the customer uses the customer terminal 4 to call an operator corresponding to the operator terminal 5.

At the step S116, the operator logs in the relay server 1 by operating the operator terminal 5. The login to the relay server 1 is carried out by the same process as usual login in usual Web service. In the embodiment of the present invention, the operator logs in the relay server 1 by using an operator ID and a password, which are assigned previously. The relay server 1 identifies the operator based on the operator ID and the password.

At the step S118, the operator terminal 5 transmits an access request with an URL data for the Web server 3 to the relay server 1. The determination module 12 determines that the access request from the operator terminal 5 is the first time access request and transfers the determination result to the cache module 15. The cache module 15 writes the determination result into the URL data table and stores in the cache data storage section 16. The URL data table can be read out from the cache data storage section 16, according to necessity. A Web page of Web contents for the URL data is downloaded from the Web contents server 3. The downloaded Web page is stored in the cache module 15 and delivered to the operator terminal 5 through the relay server 1. Thus, the operator terminal 5 browses the Web page of the Web contents on the operator terminal 5, and then holds a waiting state until receiving the call signal transmitted from the customer terminal 4, and the sharing key 82 corresponding to the customer terminal 4.

At the step S102, the customer logs in the relay server 1 through the network 7 by operating the customer terminal 4. The login to the relay server 1 is carried out by a same procedure as usual login procedure in usual Web service. In the embodiment of the present invention, the customer logs from the customer terminal 4 into the relay server 1 by using a customer ID and a password assigned previously. The relay server 1 identifies the customer based on the customer ID and the password.

At the step S104, the customer terminal 4 transmits an access request with an original URL 85 to the relay server 1 to download the Web contents from the Web contents server 3. The determination module 12 determines that this access request is not the first time access request, based on the URL data table of the cache module 15. Thus, the determination module 12 allocates the sharing key 82 to the customer terminal 4. In this way, the customer terminal 4 can form a sharing group with the operator terminal 5 based on the allocated sharing key 82. Also, the determination module 12 transfers the determination result together with the original URL 85 transmitted from the customer terminal 4 to the HTML contents rewrite module 14 of the relay server 1.

At the step S106, the HTML contents rewrite module 14 reads out the Web page of the Web contents from the cache module 15 or cache data storage section 16 through the cache module 15, refers to the assigned data table stored in the storage section 18 to determine Web sharing scripts for data sharing, and acquires the determined Web sharing scripts from the Web sharing script storage section 17. Then, the HTML contents rewrite module 14 rewrites the read out Web contents page by using the acquired Web sharing scripts. The rewritten Web page of the Web contents is stored in the cache module 15. Also, the rewritten Web page of the Web contents is downloaded to the customer terminal 4 through the browser communication section 11. The customer brows the downloaded Web page of the Web contents on the customer terminal 4. At this time, the substitution URL 8 containing the sharing key 82 is stored in a storage area (not shown) of the customer terminal 4 which can be accessed by a browser on the customer terminal 4.

At the step S108, when determining that the customer needs the operator (when trying to execute the Web contents sharing), the customer calls the operator by pushing a call button as an icon on the Web page or a physical button on the customer terminals 4. At this time, a call signal is generated.

At the step S110, in response to the pushing operation of the call button, the browser on the customer terminal 4 automatically logs in the sharing control server 2. The sharing group setting module 23 of the sharing control server 2 receives the call signal from the customer terminal 4 through the communication module 21, and allocates the operator terminal 5 to the customer terminal 4 in response to the call signal so as to start the control of the sharing group. As a result, the real-time Web contents sharing in the sharing group is automatically executed while the customer terminal 4 is connected with the sharing control server 2. Also, the difference update module 22 notifies the start of the Web contents sharing control to the costumer terminal 4 and the operator terminal 5 of the sharing group through the communication module 21. In response to the notification from the difference update module 22, the browser of the customer terminal 4 rewrites the URL data to update the identifier of the sharing status 83 of the URL 8 so as to indicate the execution state of the real-time Web contents sharing. Also, the browser of the customer terminal 4 notifies the execution of the real-time Web contents sharing to the relay server 1. In response to the notification, the determination module 12 of the relay server 1 updates the identifier of the sharing status 83 of the substitution URL 8 so as to indicate the execution state of the real-time Web contents sharing, and stores it in the URL data table. Thus, the shared browsing of the Web page is started on the customer terminal 4 at a step S112. Since the customer terminal 4 is in the Web sharing control, the customer terminal 4 automatically logs in the sharing control server 2 each time a new page of the Web contents is downloaded in response to page transition.

At the step S120, the browser on the operator terminal 5 receives the notification of the start of the Web content sharing control from the sharing control server 2. In response to the notification from the difference update module 22, the browser of the customer terminal 4 rewrites the URL data to update the identifier of the sharing status 83 of the URL 8 so as to indicate the execution state of the real-time Web contents sharing. Thus, the browser on the operator terminal 5 receives the latest Web page of the Web contents from the cache module 15 or the cache section 16 of the relay server 1. When receiving the Web page of Web contents, the operator terminal 5 automatically logs in the sharing control server 2 at a step S122, because the downloaded Web contents have a script to log in the sharing control server 2. Also, the browser of the operator terminal 5 transmits the updated URL data to the sharing control server 2 and the updated URL data is stored in the sharing group setting module 23. Thus, the shared browsing of the Web page is started on the customer terminal 4 at a step S124.

At the step S114, the customer terminal 4 is released from the real-time Web contents sharing state when it is disconnected from the operator terminal 5. The disconnection is notified to the relay server 1 and the shared control server 2. In response to the notification of the disconnection, the relay server 1 updates the identifier of the sharing status 83 of the URL 8 to indicate release from the real-time Web contents sharing, and stores it in the URL data table. The updated URL is transmitted from the relay server 1 to the customer terminal 4 and stored in a storage area of the customer terminal 4. The sharing group setting module 23 of the sharing control server 2 stops the management of the sharing state of the sharing group and notifies the disconnection of the customer terminal 4 to the operator terminal 5. When the customer terminal 4 is disconnected from the operator terminal 5, the control of the customer terminals 4 returns to the step S106 and carries out an independent browsing automatically.

At the step S126, in response to the notification of the disconnection of the customer terminals 4 from the operator terminal 5, the control of the operator terminal 5 returns to the step S118 and is set to the waiting state. By carrying out the above-mentioned operation, it is possible to carry out the real-time Web contents sharing in response to the calling from the customer terminal 4 and the operator terminal 5.

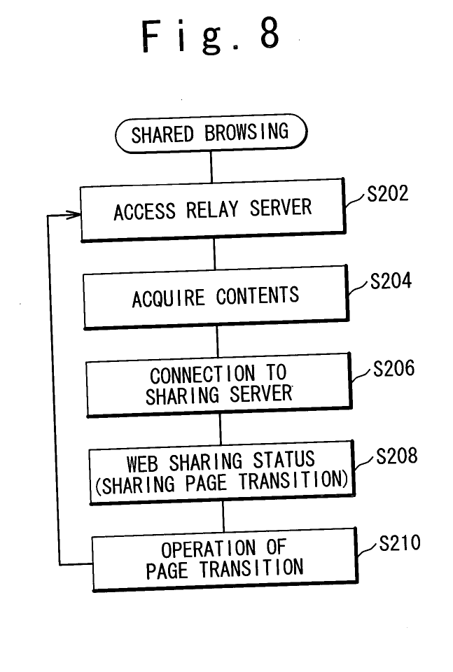

FIG. 8 is a flowchart showing an operation to carry out the real-time Web contents sharing (that is, synchronization of the Web contents). At a step S202, the customer terminal 4 displays the Web page of the Web contents downloaded from the relay server 1 corresponding to the URL 8a. At this time, in order to acquire a new Web page of the Web contents, it is supposed that a click is carried out. In response to the click, the original URL 8a is rewritten into the substitution URL 8b, in which “−1” is added to the serial number. Thus, a new access request with the substitution URL 8b is issued to the relay server 1 to access the relay server 1 through the network 7.

At the step S204, the determination module 12 refers to the URL data table to determine that the new access request is not the first time access request, based on the sharing status 83a. As a result, the next Web page of the Web contents is specified in the cache module 15 or the cache data storage section 16. The HTML contents rewrite module 14 rewrites the specified Web page of the Web contents based on the Web sharing scripts which are obtained by referring to the assigned data table stored in the storage section 18. Then, the specified Web page of the Web contents is downloaded to the customer terminal 4. In the customer terminal 4, the downloaded Web page is displayed and browsed by the customer using the browser. At this time, the Web sharing-script is executed so that the downloaded Web page is rewritten such that a user action is hooked and a difference update command is generated based on the hooked action. Also, the Web page of the Web contents is rewritten in response to the difference update command from the difference update module 22. Also, on completion of the rewrite of the Web page, a connection to the sharing control server 2 is automatically carried out.

The completion of the connection to the sharing control server 2 at the step S206 leads to the Web contents sharing state (Step S208). At the step S208, all the user actions such as a text form and a check button of the Web contents, a scrollbar, and writing are shared, and a resultant page transition based on the users action is also shared. When the page is transited at the step S210, the control of the relay server 1 is automatically carried out because the substitution URL 8b indicates the passing through the relay server 1.

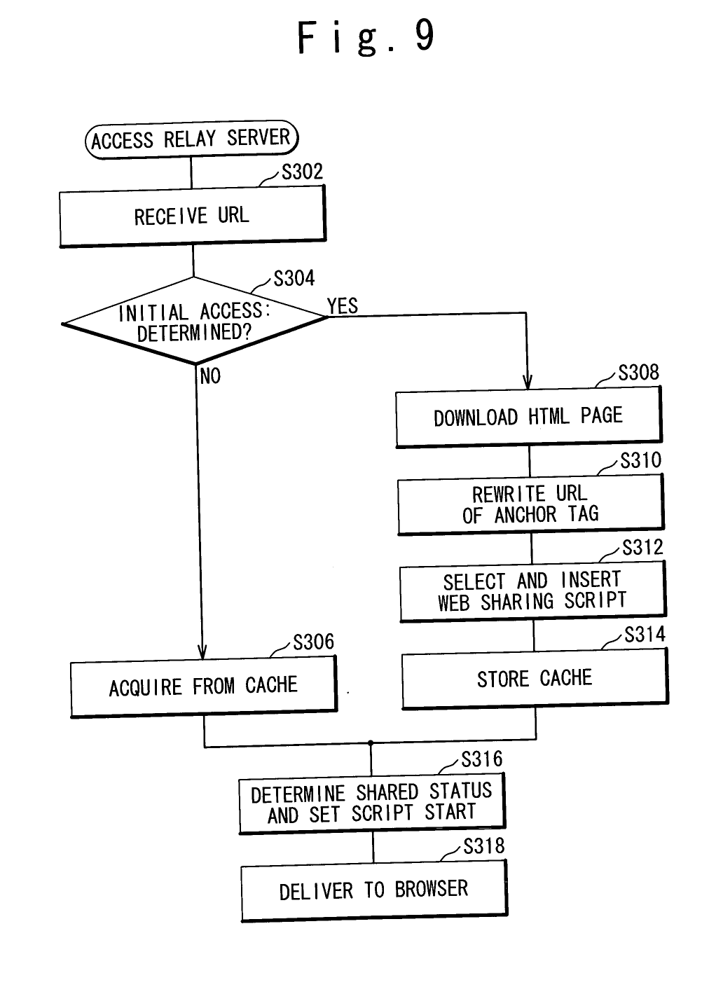

FIG. 9 is a flowchart showing an operation when the transition to another page is carried out during the shared browsing. At the step S302, in response to an instruction of transition to the other page by the customer of the customer terminal 4, the customer terminal 4 issues an access request with an URL data for a new page and the browser communication section 11 of the relay server 1 receives a destination URL of the URL data.

At the step S304, the determination module 12 determines whether the access request with the destination URL is the first time access request. This is, the determination module 12 determines whether or not the same URL data exists in the URL data table, by comparing the sharing key 82 and the serial number 84 with corresponding ones of the URL data table. It is determined that the access request is the first time access request in the sharing group, if there is no same URL data. Then, the determination module 12 requests the Web server communication section 13 to access the Web contents server 3, and sets a flag showing the downloading into the cache module 15. Contrary, the access request is determined to be carried out by another user in the sharing group if the same URL data exists, and the determination module 12 acquires the Web page of the Web contents from the cache module 15. In this case, if a downloading operation is being carried out, the determination module 12 keeps a waiting state until the download and the storage in the cache section 16 is completed. The response to the browser communication section 11 is kept to the waiting state until the Web page of the Web contents is stored in the cache module 15 regardless of whether or not the access request is the first time access request.

In this way, the sharing key 82 is used to determine whether or not the same URL data exists, in order to prevent that the Web page of the Web contents is utilized between the plurality of sharing groups. Also, the serial number 84 is used to determine whether or not the access request is the second or subsequent time access request to the same contents by the user. Therefore, when the access request is not the first time access request, the Web page of the Web contents corresponding to the destination URL is acquired from the cache module 15 or the cache data storage section 16 (step S306).

The cache module 15 responds to the inquiry of existence confirmation of the Web contents to be transmitted from the determination module 12. When the Web page of the Web contents is stored in the cache data storage section 16, the cache module 15 delivers the web page of the Web contents immediately. When the flag is set to show the downloading operation to the cache section 16, the cache module 15 responds the browser communication section 11 to wait. When the Web server communication section 13 has a transaction which is determined to be the first time access request, the flag is set to show the downloading operation of the Web page of the Web contests, and the cache module 15 instructs the browser communication section 11 to hold a waiting state.

If the determination module 12 determines that the access request to the destination URL is the first time access request at the step S304, the control proceeds to the step S308. At the step S308, the Web server communication section 13 downloads a Web page in HTML corresponding to the destination URL from the Web contents server 3. The Web server communication section 13 accesses the Web contents server 3 in response to the access request from the determination module 12. At this time, the Web contents server 3 is specified in accordance with the original URL 85 in the substitution URL 8 to acquire the corresponding Web contents. According to the completion of the acquiring, the Web server communication section 13 transfers the control to the HTML contents rewrite module 14.

At the step S310, an anchor tag URL of the downloaded Web page in HTML is rewritten by the HTML contents rewrite module 14. Also, a portion of the Web page in which URLs are specified by script programs is rewritten in addition to the anchor tag. Thus, the HTML contents rewrite module 14 rewrites the scripts such as HTML descriptions of the Web page of the Web contents transferred from the Web server communication section 13, while other contents such as images are not rewritten. In the rewrite by the HTML contents rewrite module 14, the rewrite of the original URL 85 such as the anchor tag or the relative URL 91 into the substitution URL 8 is contained. The rewritten Web page is stored in the cache module 15 or the cache data storage section 16. In this way, all accesses to the Web contents server 3 are directed to pass through the relay server 1 by this process. A full path portion of the sharing key 82, the sharing state 83, and the original URL 85 is succeeded from the URL when the relay server 1 is accessed.

At the step S312, the HTML contents rewrite module 14 determines whether the Web page of the Web contents is specific, based on the substitution URL. When the Web page of the Web contents corresponding to the URL is specific, a special Web sharing script is read out from the storage section 17 and inserted into the Web page of the Web contents. The special Web sharing script rewrites when the Web page of the web contents is downloaded to a part of the browser. The conversion or rewrite of the original URL 85 or the relative URL 91 into the substitution URL 8 may be carried out in the terminal with the browser installed. When the Web sharing script 17 is inserted, the Web sharing script to be inserted can be selected for every original URL 85 (or the relative URL 91) or the sharing user.

A general script is used for Web contents of the other Web contents server 6 since the Web contents cannot be specified previously. Addition of a button which cannot be operated on the customer terminal 4 and a memorandum which should be shown to only the operator to the contents is carried out by using a specific Web sharing script to be inserted.

The assigned data table showing correspondence relation of URL and the Web sharing script is stored in the assigned data table storage section 18. The HTML contents rewrite module 14 specifies whether the Web sharing script should execute a script function or program for connecting with the sharing control server 2 in the download of the Web page to the browser, based on the sharing status 83. The connection with the sharing control server 2 is carried out immediately in the download to the browser in case of the sharing state, whereas the script function is not executed in case of non-sharing state, since the connection is not needed. The HTML contents rewrite module 14 transfers the control to the cache module 15 when the rewrite of the Web contents is completed.

The HTML contents rewrite module 14 stores the Web page of the Web contents in the cache module 15 after the completion of the insertion of the Web sharing scripts into the Web contents (The step S314). Then, the Web page is stored in the cache data storage section 16. Further, the cache module 15 notifies the completion of the storage of the Web contents to the browser communication section 11 which holds the waiting state.

At the step S316, the Web page of the Web contents stored in the cache data storage section 16 at the step S314 or the Web page of the Web contents acquired at the step S306 is determined with respect to whether it is in the sharing state. In case of the sharing state, a start setting of the script for the customer terminal 4 to access the sharing control server 2 is carried out when the customer terminal 4 receives the Web page. Also, at the step S316, the rewrite of the Web page is carried out when the specific script is necessary for every customer terminal 4 or operator terminal 5. At the step S318, the rewritten Web page is delivered to the customer terminal 4. As a result, the real-time Web contents sharing is properly carried out and multiple accesses is prevented, even when an event of page transition is caused.

Hereinafter, the operation of the present invention is described more specifically. When the Web contents in the server is accessed, an URL (91a, 91b) of access destination is often written by using a relative URL (91). The relative URL 91 is written based on a relative path in the Web contents server 3. The relay server 1 rewrites the relative URL 91 to a first substitution URL 8a. First of all, “http://proxy.server/” is written as an URL to access the relay server 1 as a Web server. Second, “Sharing group ID—ABCD” is written as an ID (82a) to identify a sharing group. Subsequently, “TRUE” is written as an identifier of the sharing status (83a) to identify a sharing state, followed by “00000111” is written as a serial number (84a). The serial numbers are allocated to rewrite all the URLs in every sharing group. Therefore, contents are properly acquired from the Web server if different pages are clicked, even if original URLs are identical.

Also, when an anchor tag is clicked, a first substitution URL 8a of the anchor tag in the sharing group is rewritten to a second substitution URL 8b through the sharing control server 2. The serial number is followed by “−1” as an identifier (10) to identify the clicking. This indicates the first retransmission. When a user action as a Web access is caused in the real-time Web sharing, the serial number (84a) is followed by numbers such as “−1”, “−2” and “−3”. Thus, even when the same button is operated frequently, the Web access is determined to be the first time access. The above-mentioned operation is especially effective to the contents whose HTML pages are dynamically generated in the server. Particularly, over-cache of the relay server 1 due to a POST action can be prevented. The relay server 1 responds to the second and subsequent accesses from a cache unit such that the Web contents server 3 is not over-accessed due to the actions in the sharing group. However, even in such a case, the relay server 1 recognizes the first access to the Web contents through the above-mentioned processing. In this way, the accesses to the Web server corresponding to the second and third operations of a button are permitted in a site such as an auction site where the button is frequently operated.

Also, according to the present invention, the multi-access to the Web server can be prevented during the real-time Web sharing. The relay server is installed between the server and the terminal and all the access pass through the relay server. Therefore, even if it supposes that the access to the Web server is transmitted one of by the plurality of terminals in the group, the Web server is accessed. The Web contents are delivered from the cash module 15 in the relay server to another terminal in the sharing group.

Also, the Web contents of an optional Web server can be handled for the real-time Web sharing in the present invention. All the access destinations pass through the relay server. When the relay server relays an optional Web page requested from the terminal, the relay server inserts scripts and communications programs in the Web page to share the Web page in the real-time Web contents sharing among the browsers. With this, the sharing of an optional Web server becomes possible.

1. A real-time Web sharing system comprising:
a Web server which is connected with a network and which stores Web contents;
a relay server which is connected with said network and comprises a storage section, wherein when receiving an access request with an URL from one client, said relay server determines whether said access request with said URL is a first time access request to said URL, downloads the Web page of the Web contents corresponding to said URL from said Web server when it is determined that said access request is the first time access request to said URL, stores the downloaded Web page in said storage section, and delivers the Web page to said one client; and reads out the Web page from said storage section when it is determined that said access request is not the first time access request to said URL, rewrite the read out Web page and delivers the rewritten Web page to said one client; and
a sharing control server which is connected with said network, and which controls synchronization of the rewritten Web page between a plurality of clients including said one client, when the rewritten Web page is browsed by said plurality of clients.

2. The real-time Web sharing system according to claim 1, wherein said relay server comprises:
a determining section which determines whether said access request is the first time access request to said URL; and
an update section which rewrites the Web page read out from said storage section such that URLs contained in the read out Web page are rewritten into substitution URLs,
each of said substitution URL contains a sharing group data, a sharing status data and a serial number, and
said determining section determines whether the access from said client is the first time access, based on said serial number.

3. The real-time Web sharing system according to claim 2, wherein said sharing control server comprises a sharing setting section,
said relay server allocates a specific sharing group data to said one client to define a sharing group of said plurality of clients,
a synchronization request of the Web page and said specific sharing group data are transferred to said plurality of clients other than said one client,
each of said plurality of clients other than said one client downloads the rewritten Web page corresponding to said specific sharing group data from said relay server in response to said synchronous request, and
said sharing control server controls the synchronization of the rewritten Web page between said plurality of clients based on said specific sharing group data.

4. The real-time Web sharing system according to claim 3, wherein said relay server allocates another specific sharing group data to a client different from said plurality of clients in response to a new access request to said URL from said different client while the rewritten Web page is browsed by said plurality of clients, and
said sharing control server independently controls the synchronization of the rewritten Web page to said sharing group corresponding to said specific sharing group data and the synchronization of the Web page to another sharing group corresponding to said another specific sharing group data.

5. The real-time Web sharing system according to claim 2, wherein said determining section determines that said access request with said URL is the first time access request when there is no access request to said serial number, and
said update section gives an access data to said serial number in response to the determination that said access request with said URL is the first time access request.

6. The real-time Web sharing system according to claim 5, wherein said determining section determines that a first access request to said substitution URL with said access data added to said serial number is not the first time access request, and generates a first notice of said first access request to said substitution URL with said access data added to said serial number to said update section, and
said update section updates said access data of said substitution URL with said access data added to said serial number in response to said first notice.

7. The real-time Web sharing system according to claim 6, wherein said determining section determines that a second access request to said substitution URL with said access data added to said serial number is the first time access request when transition of the Web page is not detected, and generates a second notice of said second access request to said substitution URL with said access data added to said serial number to said update section, and
said update section updates said access data in response to said second notice.

8. The real-time Web sharing system according to claim 2, wherein said relay server further comprises a script storage section which stores a script program to rewrite the Web page, and
delivers said script program corresponding to said access request in addition to the rewritten Web page to said one client when said access request is not the first time access request.

9. The real-time Web sharing system according to claim 8, wherein said script storage section stores said script program corresponding to each of a plurality of said Web servers connected with said network, and
said relay server selects one of said plurality of Web servers based on said access request from said one client, and delivers said script program corresponding to said selected Web server and the rewritten Web page corresponding to said access request to said one client.

10. The real-time Web sharing system according to claim 3, wherein each of said plurality of clients other than said one client transmits a reception notice to said relay server in response to the allocation of said specific sharing group data, and
said relay server sets a code in said sharing status data in response to the allocation, and controls connection to said sharing control server based on said code.

11. The real-time Web sharing system according to claim 3, wherein said relay server delivers said rewritten Web page to a new client in response to a new access request to the rewritten Web page, to which the synchronization is controlled, from a new client different from said plurality of clients, and
said sharing control server controls the synchronization between said new client and said plurality of clients.

12. A computer readable software product for realizing a process comprising:
receiving an access request with an URL from one client of a plurality of clients;
determining whether said access request with said URL is a first time access request to said URL;
downloading the Web page of the Web contents corresponding to said URL from a Web server when it is determined that said access request is the first time access request to said URL;
storing the downloaded Web page in a storage section;
delivering the Web page to said one client;
reading out the Web page from said storage section when it is determined that said access request is not the first time access request to said URL;
rewriting the read out Web page; and
delivering the rewritten Web page to said one client.

13. The software product according to claim 12, wherein said rewriting comprises:
rewriting the Web page read out from said storage section such that URLs contained in the read out Web page are rewritten into substitution URLs,
each of said substitution URL contains a sharing group data, a sharing status data and a serial number,
said determining comprises:
determining whether the access from said client is the first time access, based on said serial number.

14. The software product according to claim 13, wherein said process further comprises:
allocating a specific sharing group data to said one client to define a sharing group of said plurality of clients,
a synchronization request of the Web page and said specific sharing group data are transferred to said plurality of clients other than said one client,
each of said plurality of clients other than said one client downloads the rewritten Web page corresponding to said specific sharing group data from said relay server in response to said synchronous request.

15. The software product according to claim 14, wherein said process further comprises:
allocating another specific sharing group data to a client different from said plurality of clients in response to a different access request to said URL from said different client while the rewritten Web page is browsed by said plurality of clients.

16. The software product according to claim 13, wherein said determining comprises:
determining that said access request with said URL is the first time access request when there is no access request to said serial number, and
said rewriting comprises:
giving an access data to said serial number in response to the determination that said access request with said URL is the first time access request.

17. The software product according to claim 16, wherein said determining comprises:
determining that a first access request to said substitution URL with said access data added to said serial number is not the first time access request; and
generating a first notice of said first access request to said substitution URL with said access data added to said serial number, and
said rewriting comprises:
updating said access data of said substitution URL with said access data added to said serial number in response to said first notice.

18. The software product according to claim 17, wherein said determining comprises:
determining that a second access request to said substitution URL with said access data added to said serial number is the first time access request when transition of the Web page is not detected; and
generating a second notice of said second access request to said substitution URL with said access data added to said serial number, and
said rewriting comprises:
updating said access data in response to said second notice.

19. The software product according to claim 13, wherein said delivering the rewritten Web page comprising:
delivering said script program corresponding to said access request in addition to the rewritten Web page to said one client when said access request is not the first time access request.

20. The software product according to claim 19, wherein said delivering the rewritten Web page comprising:
selecting one of said plurality of Web servers based on said access request from said one client; and
delivering said script program corresponding to said selected Web server and the rewritten Web page corresponding to said access request to said one client.

21. The software product according to claim 14, wherein said process further comprises:
generating a reception notice from each of said plurality of clients other than said one client in response to the allocation of said specific sharing group data,
said rewriting comprises:
setting a code in said sharing status data in response to the allocation, and controls connection to said sharing control server based on said code.
